(19) United States
(12) Patent Application Publication
(10) Pub. No.: US 2005/0163994 A1
(43) Pub. Date: Jul. 28, 2005

(54) Multilayer polymer film, process for preparing it, and process for protecting and cleaning a surface using this film

(75) Inventors: Franck Rouppert, ST Pierre Bressieux (FR); Emmanuelle Ackermann, Pariset (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 10/980,173

(22) Filed: Nov. 4, 2004

(30) Foreign Application Priority Data
Nov. 5, 2003 (FR) 03 50794

(51) Int. Cl. B05D 3/00; B32B 27/30; B32B 27/32; B32B 27/18

(52) U.S. Cl. 428/339; 427/331; 427/372.2; 428/411.1; 428/522; 428/523; 428/500

(57) ABSTRACT

Multilayer film comprising a surface layer and at least one other layer under the said surface layer, each of the said surface layers and of the other layers comprising at least one organic polymer and being free of complexing agents, chelating agents and, optionally, mineral fillers, and the said surface layer also comprising at least one agent capable of promoting the removal of the said surface layer by a rinsing liquid. Process for preparing this film. Surface layered with this film and substrate comprising this surface. Process for protecting a surface against contaminants or pollutants using the said film and process for cleaning or decontaminating a surface similarly using the said film. The invention applies in particular to the protection of surfaces such as walls, facades and road signs against graffiti.

The present invention relates to a multilayer polymer film or skin.

The invention also relates to the process for preparing and forming such a polymer film.

The invention also relates to a surface coated with such a film or such a skin, and to a substrate comprising such a coated surface.

Finally, the invention relates to a process for protecting a surface against contaminants or pollutants using the said film and to a process for cleaning or decontaminating a surface similarly using the said film.

The technical field of the invention may be defined in general as that of cleaning, treating or decontaminating surfaces and/or protecting these surfaces against contaminants or pollutants, whether they are chemical, radioactive, biological or bacteriological contaminants or pollutants.

More specifically, the field of the invention is more particularly that of protecting surfaces, especially wall surfaces, facades, road signs, etc., against graffiti and other unwanted inscriptions, and of cleaning these surfaces to remove these unwanted graffiti and inscriptions therefrom.

The term “graffiti” generally denotes [1], any painting, inscription, drawing or other unwanted forms of marks on a given surface. Graffiti is generally applied in the form of paints in aerosol cans, or ink markers.

At the present time, there are essentially four processes for protecting a surface against graffiti or for removing graffiti from the said surface:
cleaning by abrasion, for example by sand-blasting or by spraying with chalk, which is an aggressive and expensive technique, requires a lot of man hours, releases harmful particles and damages the surfaces;
the application of a new coat of paint does not remove the graffiti, but merely allows it to be hidden when it is applied on a painted surface,
cleaning with chemical solvents uses aggressive chemical products, generates numerous pollutant effluents and degrades the surfaces;
a final category of processes in which the process of the invention may be classified involves the use of protective coatings.

Protective coatings prevent the graffiti from penetrating and attaching by modifying the surface properties and via a barrier effect.

There are two types of protective coatings: temporary or sacrificial coatings, and permanent coatings.

The existing sacrificial coatings are based on natural or synthetic waxes, based on acrylic polymers or based on polysaccharides [2-6]. However, the materials described in the said documents have major drawbacks: thus, waxes melt too easily with heat and in water, chemical solvents are used to remove them and, finally, it is necessary to apply a fresh coating layer after each graffiti attack.

More specifically, document [2] describes a process for protecting buildings against graffiti, in which the buildings liable to be soiled are covered with a thin film of paraffin. The paraffin may be applied in hot-melt form or in the form of an aqueous emulsion. The soiled film is removed, with great difficulty, by means of brushes, scrapers or knives, or by melting the paraffin, or alternatively by burning off the film.

The major drawback of the process of the said document is thus that of using a film that is extremely difficult to remove.

Document [3] relates to a non-stick composition, especially for protecting various supports against graffiti, containing in aqueous medium at least one synthetic wax derived from plant wax, combined with a nonionic emulsifier and/or a microcrystalline wax.

The soiled composition may be removed from the support by brushing or using a stripper, especially in the case of very coarse supports.

The composition of the said document has the drawbacks of not being long-lasting and of being usable only once.

Document [4] describes an anti-graffiti coating system comprising an actual coating agent and a regenerating cleaning agent. The coating agent comprises a “base” composition and an “anti-graffiti additive” composition.

The base is a composition from the group comprising acrylic and hydroxylated resins and their isocyanate hardener; and acrylic copolymer resins dissolved in aromatic and ketonic solvents. The anti-graffiti additive is a composition incorporating a polyethylene wax, a silicone oil, a blend of polyurethanes and an acrylic solution. The cleaning agent is a mixture of polyethylene wax and of a polar synthetic oil.

The system of the said document is expensive and is not long-lasting.

Document [5] relates to an anti-graffiti solution formed by combining a polyvinyl alcohol with an acrylic resin solution or emulsion, in order to form a partially crosslinked polyvinyl alcohol/acrylic mixed resin, catalysed by exposure to heat and/or to light.

The properties of the solution are improved by adding a solution of a zinc complex containing zinc tetraamine and/or an aldehyde donor such as formaldehyde or glyoxal.

In extreme cases of degradation, the protective film may be considered as a sacrificial membrane. It may be removed by washing with a solvent such as toluene alternating with a caustic soda solution or aqueous ammonia, and rinsing with water.

The said document comes up against problems of high cost and high toxicity.

Document [6] describes a process for protecting a surface against contaminants and for facilitating the removal of the said contaminants from this surface, in which:
a solution is prepared containing a polysaccharide, which comprises at least two different polysaccharides, the first of these polysaccharides directly forming a film when it precipitates by evaporation of a solvent in the solution, and the second polysaccharide forms a film at least partially by formation of a gel when it is precipitated from a solution by evaporation of a solvent present therein, or the second polysaccharide forms a film at least partially by formation of a gel during interaction with the said first polysaccharide during the precipitation with evaporation of a solvent; the said films are capable of being redissolved or are swellable and the solution containing the polysaccharides comprises a buffer to compensate for the pH variations;
the solution is applied to a surface subject to contamination;
the solution on the surface is dried to form a solid film on the surface at least partially by formation of a gel;
the surface is exposed to a source of potential contamination;
the surface coated with the film is treated with a liquid capable of redissolving the film or of making the film swell;
the unwanted contamination deposited on the surface is removed by totally or partially removing the film from the said surface.

The process of the said document has the drawback of using solvents.

The permanent coatings currently proposed are mainly based on polyurethanes (PU), silicones and fluoro compounds [1]. However, polyurethane is extremely moisture-sensitive and has a mediocre surface appearance. Silicones have a long polymerization time and are permeable to oils. Fluoro compounds are toxic and require chemical solvents.

A number of products that have non-stick properties with respect to paints and inks also exist, but they have the drawback of being very expensive, i.e. about 15 Euros per m² treated in terms of material cost, and in addition of losing their efficacy after 3 or 4 cleaning operations.

Thus, document [7] concerns a process for treating a surface to form this coating thereon, the coating having a coloured and textured surface to which graffiti cannot easily be applied. In this process:
a first coat of a sizing and sealing coating containing an aggregate and a binder is applied to the surface to be coated;
a coating composition containing an aqueous mixture of a plaster-based material, a binder, a filler to harden the coating composition, and a water-soluble dye is applied to the exposed surface of the said first coat;
texturing of the exposed surface of the second coat is performed to form a relief thereon;
the said second coat is hardened;
a cellulose-based finishing coat containing the dyestuff is applied to the second hardened coat.

The process of the said document modifies the appearance of the surface and the coating composition may, in fact, be considered more or less as a paint.

Finally, document FR-A-2 822 835 describes a film, which is dispersible as an emulsion in water, comprising a polymer and containing at least one chelating or complexing agent that allows the decontamination, cleaning and/or protection of various surfaces, especially metal surfaces.

The “removable” film of the said document, which is formed on the surface by applying an aqueous latex emulsion thereto, in the same manner as a paint, makes it possible, when it is removed from the surface, to entrain with it the impurities present. This film can allow, when it is removed from a surface of moderate coarseness, inscriptions found thereon to be entrained with it. However, although this removable polymer film is inexpensive, i.e. about 2 Euros per m² treated, in terms of material cost, it can only be used once, since it must be removed. This removal may prove to be difficult on very coarse surfaces such as roughcasts or raw cement, whereas on surfaces on which its adhesion is lower, for instance road signs or glazing, it may possibly be removed by the “graffiti artists” before the graffiti is applied.

Furthermore, certain components of its formulation, for instance the fillers, complexing agents and chelating agents, are harmful and opacify or colour the film, for example, while entailing an additional cost.

It has also been found that organic or mineral residues, generally in the form of particles, originating from the film, described in the said document, were present on the surface on which it had been applied, and then removed. In addition, the same particles might cause degradation of the condition of the surface during the application of the emulsion.

It is seen that none of the techniques described in the prior art documents mentioned above is effective enough to allow a total removal of graffiti from surfaces, and that, in addition, the existing techniques are expensive in terms of labour time and consumption of chemical reagents, damage the surfaces and generate effluents.

There is a need for a polymer film and a process allowing the decontamination, cleaning and/or protection of various surfaces and which make it possible to totally remove the pollutants or contaminants from these surfaces.

In particular, there is a need for a polymer film that makes it possible to totally remove graffiti and any other unwanted inscriptions and markings from any surfaces such as walls, facades, road signs, etc., and/or that makes it possible to protect these surfaces against these inscriptions and graffiti with great efficacy. In other words, there is a need for a polymer film that allows perfect cleaning or protection of the surface onto which it is applied, and from which it is subsequently removed, i.e. a film that totally removes all the pollutants or contaminants from the said surface, for instance the pollutants or contaminants resulting from graffiti, markings and inscriptions.

There is also a need for a polymer film which, while completely removing the contaminants or pollutants arising from the surface, does not leave any residues, particles or the like on the surface during the application of the emulsion (or solution) containing it.

Furthermore, there is a need for a film that can be readily and completely removed after its use, and that allows easy separation and recovery of the constituents and of the trapped pollutant contaminants. In other words, the film and the process should ensure excellent recovery and purification of the upgradable materials, together with a low impact on the environment.

This film and the process using it should, furthermore, be effective with respect to all contaminants, in particular all the contaminants of which markings, graffiti or the like are composed, irrespective of their form: solid or liquid particles and the like, and of their nature: chemical, radioactive, biological and the like.

This film and this process should finally be inexpensive, easy to use, safe and reliable, sparingly aggressive with respect to the treated surface and, if possible, should conserve, on the surface, the visual appearance of an untreated surface.

In the case of a coating more particularly intended for removing graffiti from surfaces and/or for protecting these surfaces against graffiti, the criteria and demands that must be satisfied by such a coating are, inter alia, the following:
the adhesion of the coating should be good with the surface to be treated, and low with the graffiti;
the surface aspect of the coating defined especially by its coarseness, its colour, its transparency and its gloss, should be able to be adapted to the treated support;
the coating should be impermeable to air, to allow the surface to breathe, and impermeable to the marker solvents and to the paints of which the unwanted graffiti, inscriptions and markings are composed;
the coating should be chemically inert;
the constituents of the coating should not show any toxicity;
the storage time of the constituents of the coating before use and the service life of the coating should be satisfactory; in particular, the coating should be able to withstand prolonged exposure to both high and low temperatures, to moisture, to UV rays and to other atmospheric factors, and also to mechanical stresses; finally, the coating should be able to remain for long enough to be able, for example, to allow the repeated removal of several graffiti marks successively applied to the surface.

In addition, a process for removing graffiti, for example, from a surface and/or for protecting the said surface using such a coating should also satisfy a certain number of criteria and demands that are, inter alia, the following:
the application of the coating or film to the surface to be protected or treated should be performed via a simple process and, for example, with a roller or by spraying;
the drying of the film or coating applied should be rapid;
the coating should be able to be used under wide ranges of conditions, for example of temperature, humidity and pH, and these working ranges should be fully known and defined;
the removal of the coating should be performed simply, but specifically, so as to avoid any unwanted removal;
the process should be inexpensive, rapid, should not deteriorate the surfaces, and should be able to be repeated many times, so as to allow the repeated removal of several graffiti marks successively applied to the surface.

The aim of the present invention is to provide a polymer film and a process for cleaning, decontaminating or protecting a surface, which satisfies, inter alia, all of the needs mentioned above and which satisfies the demands, criteria and conditions stated above for such a film and such a process.

The aim of the present invention is, in particular, to provide a polymer film and a process for cleaning or protecting a surface with respect to unwanted graffiti, markings and inscriptions, which satisfies, inter alia, all of the needs mentioned above, in the context of this particular application, and which satisfies the demands, criteria and conditions stated above for such a film and process.

The aim of the present invention is also to provide a film and a process that do not have the drawbacks, defects, limitations and disadvantages of the films and processes of the prior art, and that solve the problems of the prior art.

This aim and others are achieved, in is accordance with the invention, by means of a multilayer film comprising a surface layer and at least one other layer under the said surface layer, each of the said surface layers and of the said other layers comprising at least one organic polymer and being free of complexing agents, chelating agents and, optionally, possibly, of mineral fillers, and the said surface layer further comprising at least one agent capable of promoting the removal of the said surface layer by a rinsing liquid.

Advantageously, at least one of the said other layers under the said surface layer further comprises at least one agent capable of promoting the removal of the said layer by a rinsing liquid.

The multilayer film may advantageously comprise, alternately, a first layer comprising at least one agent capable of promoting the removal of the said first layer by a rinsing liquid, and a second layer not comprising any agent capable of promoting the removal of the said second layer by a rinsing liquid.

Advantageously, all the layers comprise at least one agent capable of promoting their removal by a rinsing liquid.

Preferably, two successive layers each contain a different agent capable of promoting the removal of the said layers by a different rinsing liquid.

Thus, the film according to the invention may comprise, alternately, a first layer comprising a first agent capable of promoting the removal of the said first layer by a rinsing liquid, and a second layer comprising a second agent that is different from the first agent and is capable of promoting the removal of the said second layer by a rinsing liquid.

The said different agents preferably differ in at least one of the conditions under which they promote the removal of the layer in which they are present, by the rinsing liquid.

The said conditions are chosen, for example, among the temperature, the pH, the composition of the rinsing liquid, and the pressure of the rinsing liquid, such as water.

Advantageously, the agent(s) capable of promoting the removal of a layer by a rinsing liquid is (are) chosen from agents capable of promoting the dissolution of the layer in a rinsing liquid, and agents capable of promoting the emulsification of the layer in a rinsing liquid.

The film according to the invention may generally be defined as being a film that may be dispersed as an emulsion in water or that may be dissolved as a solution in water.

The agents capable of promoting the dissolution of a layer are advantageously chosen among surfactants, preferably from nonionic, anionic and cationic surfactants; and other additives, such as acids or bases.

Examples of nonionic surfactants are fatty acid esters, examples of anionic surfactants are sulfonates and carboxylates, and examples of cationic surfactants are alkylamines.

Advantageously, the said surfactants and additives are chosen among surfactants allowing the dissolution of the layer in which they are present under the effect of an acidic washing liquid, and surfactants allowing the dissolution of the layer in which they are present under the effect of a basic washing liquid.

Advantageously the film comprises, alternately, a layer comprising a first surfactant A and a layer comprising a second surfactant B that can be dissolved under different washing conditions.

Preferably, the first surfactant A is a surfactant that promotes or allows the dissolution of the layer in which it is present by an acidic washing liquid, and the second surfactant B is a surfactant that promotes the dissolution of the layer in which it is present by a basic washing liquid, or vice versa.

Advantageously, the surface layer is a thin layer generally from 5 to 500 μm and preferably from 5 to 100 μm thick.

Generally, the total thickness of the film is from 5 μm to 2 mm and preferably from 50 to 500 μm.

Generally, there are from 1 to 50 and preferably from 1 to 20 layers other than the surface layer.

The polymer film according to the invention differs fundamentally from the films of the prior art and in particular from the films described in document FR-A-2 822 835.

Specifically, the film according to the invention has a particular structure, in the sense that it is a multilayer film, i.e. a film comprising several layers, which comprises a surface layer and at least one other layer underneath the said surface layer. This already constitutes an essential difference compared with the films of the prior art, which are one-layer films. In addition, the surface layer of the film according to the invention is a particular layer that specifically contains at least one agent capable of promoting the removal of the said surface layer by a rinsing liquid.

The film according to the invention satisfies all the needs mentioned above, satisfies all the criteria, conditions and requirements stated hereinabove, and solves the problems of the prior art mentioned above.

The film according to the invention may be defined as being a multilayer film with programmed surface removal, for example programmed surface dissolution, by treatment of the said surface layer and possibly of one or more other layers with a rinsing liquid, for example with a determined, given rinsing solution, which is generally adapted to the agent capable of promoting the removal, for example the dissolution, present in the said layer(s).

During a specific rinsing or washing, the treated surface layer dissolves and entrains with it the pollutants and contaminants, for example the paint or ink of which the graffiti, markings or inscriptions are composed, without deteriorating the lower coating. In this case, the film may be reused several times by retreating its surface with thin layers such that these layers contain each time one or more agents promoting the removal or dissolution of the surface layer, until all the thickness of the film has been consumed.

The film according to the invention may thus be used several times, and it protects the surface to which it has been applied, especially against several successive cycles of inscription followed by cleaning.

In the context of the preferred application of the film according to the invention, which is the combat against graffiti, markings and other unwanted inscriptions, the film according to the invention has the advantage of being totally impermeable to inks and paints and other constituents of these graffiti, markings and inscriptions.

Besides the advantages and effects associated with the specific multilayer structure and with the specific nature of the surface layer of the film according to the invention, the polymer film according to the invention also differs fundamentally from the films of the prior art, and in particular from the films described in document FR-A-2 822 835, in that it is free of chelating agents, complexing agents and, optionally, mineral fillers.

By virtue of the absence of chelating agents, complexing agents and optionally mineral fillers in the films according to the invention, no organic or mineral residue, for example in the form of particles, originating from the film is left on the surface onto which it is applied and then removed.

It has been demonstrated, specifically, according to the invention that certain components of the film formulation described in document FR-A-2 822 835 were unnecessary or harmful, in particular in the case of the anti-graffiti treatment of surfaces, and left residues on the surface after removal.

In addition, due to the fact that the emulsion from which the film according to the invention is prepared does not comprise any complexing agents, chelating agents or, preferably, fillers, the emulsion from which the film is prepared does not contain any particles liable to cause degradation of the surface state when the emulsion is applied.

The absence of complexing agents, chelating agents and optionally fillers from the film according to the invention also entails a reduction in the cost of the film formed and simplifies the preparation of the formulation from which the film is prepared.

Finally, the absence of complexing agents, chelating agents and optionally fillers from the film according to the invention avoids the coloration or opacification of the film, which is particularly advantageous in the preferred anti-graffiti application of the film according to the invention, in which it is desired to conserve the visual appearance of the treated surface.

In particular, it has been noted that the absence of fillers does not harm the overall properties of the film since it does not suffer any high mechanical stresses (specifically, peeling of the film is not obligatory, and in addition the mechanical properties of the film may be improved by adding other polymers such as PVA, which thus avoid the need to use fillers), but it makes it possible, on the other hand, to obtain, after removal of the film, perfectly clean surfaces, which has never been achieved in the prior art and which has been demonstrated by analysis by infrared spectrometry.

Besides the essential effects and advantages associated with the specific multilayer structure, and with the absence of completing agents, chelating agents and optionally fillers, the film according to the invention has all the advantageous properties already presented by the film of document FR-A-2 822 835, due to the fact that this film comprises a polymer that is generally non-soluble or insoluble in water.

Specifically, the film according to the invention is prepared from an aqueous emulsion of the said polymer(s) and, as a result, the polymer may be readily recovered after the film has been used by reemulsification and reflocculation, which is not possible with the water-soluble polymers of some of the films of the prior art.

The film according to the invention satisfies all the needs, demands and criteria mentioned above, for example: it makes it possible, with great efficacy and great reliability, to curatively or preventively trap the contaminants or pollutants in a sacrificial surface layer on the treated surface, i.e. it is not only the contamination present on the surface that is trapped, but also the contamination present immediately underneath this surface.

The film according to the invention allows control of the dissemination of the contaminant, by retaining the said contaminant within the film.

The mechanical, adhesive and cohesive properties of the film are excellent, even in the possible absence of fillers, and ensure very good hold on any surface, while at the same time allowing easy removal, in particular by peeling.

The film is of low cost. It may be prepared with products that are readily commercially available and via processes that are easy to perform, for example by applying an emulsion simply with a brush or by spraying the said emulsion onto the surface.

The film is not aggressive with respect to the surface to which it is applied. It does not in any way change the properties of this surface (it may even improve them), even after a long period, for example during prolonged storage.

It does not degrade the appearance of the surface. In addition, in most cases, since the film is colourless and transparent, it does not affect the visual appearance of the surface.

The film is prepared from compounds that are non-toxic with respect to the operators, and of low environmental impact.

In addition, all the constituents of the film may be readily separated, recycled and/or destroyed, at low cost, after the film has been used.

The film according to the invention allows perfect cleaning of the surface to which it is applied, and then removed; it does not leave any residue on this surface.

Thus, it has been shown that no organic trace derived from residues of the film is detectable on the surface after removing the film, as has been confirmed by analysis of the surface after removing the film, by infrared spectrometry with a multi-reflection attentuated total reflection accessory, in the spectral range from 4000 to 600 cm⁻¹.

The film according to the invention provides long-lasting protection against external pollutants and contaminants of any nature.

Advantageously, the film according to the invention is non-porous.

The polymer is generally chosen from polymers that may be in the form of aqueous emulsions of latex type.

Preferably, this polymer which may be in the form of an aqueous emulsion is chosen from styrene-butadiene copolymers, styrene-(meth)acrylic copolymers, for example styrene-(meth)acrylate copolymers (see below for the definition of the term “(meth)acrylic”) and (meth)acrylic polymers (homopolymers and copolymers).

The term “(meth)acrylic polymer” generally means any copolymer or homopolymer that may be prepared by polymerization of acrylic acid, methacrylic acid and esters thereof: for instance (C₁ to C₆) alkyl acrylates and methacrylates, such as methyl or ethyl(meth)acrylate.

Advantageously, the film may comprise several polymers that may be in the form of aqueous emulsions, preferably chosen from styrene-butadiene copolymers (SBR) and styrene-(meth)acrylic copolymers, for example styrene-(meth)acrylate copolymers, which also preferably have different glass transition temperatures (Tg).

Advantageously, a polymer such as a styrene-butadiene, referred to as a self-dispersing polymer, may be used.

The film may also comprise one or more other polymers which are polymers that may be in aqueous solution (these polymers are generally in minor amount) (rather than in emulsion), which are preferably chosen from polyvinyl alcohol (PVA) and PVP (polyvinylpyrrolidone).

Some of these polymers, such as PVA, make it possible to improve the mechanical properties and to avoid the use of fillers.

Preferably, in order especially to facilitate the preparation of the film, all the layers (surface and other layers) of the film comprise the same polymer(s). This means that these layers differ only by the presence or absence of an agent for facilitating their removal and/or by the nature of the said agent.

The invention also relates to a process for forming a multilayer film as described above, comprising a surface layer and one other layer underneath the said surface layer, the said surface layer and the said other layer comprising the same organic polymer and being free of complexing agents, chelating agents and optionally mineral fillers, in which the following successive steps are performed:
a)—an aqueous emulsion of the said organic polymer is formed;
b)—the said emulsion comprising the organic polymer is applied to the surface, by means of which the film forms by coalescence;
c)—the surface of the said film is impregnated with at least one agent capable of promoting the removal of a surface layer of the film by a rinsing liquid, so as to form a surface layer of the film containing at least one agent capable of promoting the removal of the said surface layer from the film by a rinsing liquid.

The film generally forms quickly, within a few minutes, for instance from 1 or 2 to 10 minutes, on the surface, by coalescence.

Advantageously, the film forms by coalescence at room temperature or at the service temperature of the surface (temperature at which the surface is found) without any drying of the surface, and/or of the components of which this surface is composed.

Specifically, taking into account the conditions generally used for the use of the emulsion intended to form the film according to the invention, namely with unqualified operatives, and in order to reduce the complexity of the equipment used to form the film, the ability to form a film without drying is an important advantage of the film and of the process according to the invention.

According to the invention, the formation of the film may take place at room temperature without any heating of the components to be covered and without using hot air, including formation on vertical surfaces, which is particularly advantageous.

The coalescence conditions are advantageously chosen so as to avoid any porosity, whether it is open or closed, in the final formed film obtained.

However, under certain working conditions, the process of the invention also comprises, between steps b) and c), a step of drying the film.

The formation and the optional drying of the film are performed according to the invention without any draining or any absorption of any of the liquids included in the composition of the emulsion.

In this process, the agent capable of promoting the removal of the surface layer of the film is chosen from agents capable of promoting the dissolution of the surface layer, such as surfactants.

In a second embodiment, the invention relates to a process for forming a multilayer film, as described above, comprising a surface layer and at least one other layer underneath the said surface layer, the said surface layer and the said other layer comprising the same organic polymer and being free of complexing agents, chelating agents and optionally mineral fillers, in which the following successive steps are performed:
a) an aqueous emulsion of the said organic polymer is formed;
b) the said emulsion is separated into a first portion and a second portion,
c) a first agent capable of promoting the removal of a layer of the organic polymer under the effect of a rinsing liquid is added to the first portion,
d) optionally, a second agent capable of promoting the removal of a layer of the organic polymer under the effect of a rinsing liquid is added to the second portion,
e) the said second and first portions of the emulsion are successively applied to a surface, by means of which a film is formed, comprising, from its surface, a layer comprising a first agent capable of promoting its removal by a washing liquid and a second layer comprising a second agent capable of promoting its removal by a washing liquid or not comprising the said second agent,
f) step e) is optionally repeated, for example from 1 to 40 times and preferably from 1 to 20 times.

After applying the second portion and the first portion of the emulsion, the layers form under the conditions already described above, generally quickly, for example within a few minutes, for example in 1 or 2 to 10 minutes by simple coalescence.

In this second embodiment of the process for forming the film according to the invention, the said first and second agents preferably differ in at least one of the conditions under which they promote the removal, for example the dissolution, of the layer in which they are present, by the rinsing liquid.

Advantageously, the said conditions are chosen from the temperature, the pH, the composition of the rinsing liquid, and the pressure of the rinsing liquid.

The first agent is, for example, a surfactant A and the second agent is, for example, a surfactant B.

Preferably, the surfactant A is a surfactant that promotes the dissolution of the layer in which it is present under the effect of an aqueous washing liquid, for example an acidic aqueous washing solution, and the second surfactant B is a surfactant that promotes the dissolution of the layer in which it is present under the effect of an aqueous washing liquid, for example a basic aqueous washing solution, or vice versa.

As in the case of the first embodiment of the process for forming a film according to the invention, the said formation takes place by coalescence at room temperature or at the service temperature of the surface.

However, a final step g) of drying the film may be envisaged.

The invention also relates to a process for protecting, cleaning or decontaminating a surface, in which the following successive steps are performed:
a film as described above is formed on the said surface;
the film is left in contact with the said surface until it has been contaminated or polluted, especially with graffiti or other unwanted inscriptions or markings; and
the surface layer of the said film is removed by rinsing with a liquid, preferably an aqueous liquid, such as an aqueous solution.

The surface on which the film is formed is essentially a clean surface, free of pollutants or contaminants, these latter generally being derived from the external medium that is in contact with the surface layer.

In a first preferred embodiment of this process for protecting, cleaning and decontaminating a surface, the following successive steps are performed:
a) a film is formed on the said surface via the process for forming a film in its first embodiment,
b) the film is left in contact with the said surface until it has been contaminated or polluted, especially with graffiti or other unwanted inscriptions or markings,
c) the polluted or contaminated surface layer of the said film is removed by rinsing with a liquid, preferably an aqueous liquid such as an aqueous solution, and
d) the surface of the film is optionally impregnated with at least one agent capable of promoting the removal of a surface layer from the film, so as to form a surface layer containing at least the said agent,
e) steps c) and d) are optionally repeated until the film has been consumed.

In a second preferred embodiment of the process for protecting, cleaning or decontaminating a surface, the following successive steps are performed:
a) a film is formed on the said surface via the process for forming a film in its second embodiment,
b) the film is left in contact with the said surface until it has been contaminated or polluted, especially with graffiti or other unwanted inscriptions or markings,
c) the first polluted or contaminated layer of the said film is removed by rinsing with a liquid,
d) the film is left in contact with the said surface until it has been contaminated or polluted,
e) the polluted or contaminated second layer of the said film is removed by rinsing with a liquid, preferably an aqueous liquid, such as an aqueous solution,
f) steps b) to e) are optionally repeated until the film has been consumed.

Preferably, the first and second layers are removed under different rinsing conditions such as different temperatures, different pH, different compositions of the rinsing liquid or different pressures of the rinsing liquid.

Advantageously, the first layer, which contains a surfactant A, is removed by washing with an aqueous liquid, for example an acidic aqueous washing solution, and the second layer, which contains a surfactant B, is removed by washing with an aqueous liquid, for example a basic aqueous washing solution.

In the case where the removal of the surface layer of the film according to the invention is performed by dissolving the film in aqueous medium, an aqueous solution or emulsion containing the organic material and the contaminants or pollutants is thus obtained. The organic material is separated from the solution by flocculation, followed by filtration. It is then generally discarded or removed, for example by incineration.

The contaminants or pollutants are separated out by filtration.

The invention also relates to a surface layered with the film as defined above, and a substrate, in particular an optical element or component comprising such a surface.

The invention will now be described in detail in the description that follows, which is given by way of non-limiting illustration, in particular of certain preferred embodiments of the invention.

The process begins in a first step by formulating, by preparing an aqueous emulsion of one or more polymers, of latex type.

In the present description, the term “polymer” means both homopolymers and copolymers prepared from several monomers.

Among the preferred polymers and copolymers that may be mentioned are copolymers of styrene with butadiene (SBR) or of styrene with a (meth)acrylic compound such as a (meth)acrylate.

These copolymers may have different styrene contents, or alternatively (meth)acrylic polymers.

It is again recalled that the term “(meth)acrylic polymer” means any copolymer or homopolymer that may be prepared by polymerization of acrylic acid, methacrylic acid and esters thereof, for instance (C₁ to C₆) alkyl acrylates and methacrylates, such as methyl or ethyl(meth)acrylate.

Preferably, an aqueous emulsion of commercially available latex is used; examples of such emulsions are the emulsions available from the company Bayer®, under the name Baystal®.

These emulsions especially have the advantage of low cost, very low toxicity and absence of organic solvent.

The emulsion may comprise only one polymer capable of being in the form of an aqueous emulsion, but it may also comprise two or more of these polymers, preferably chosen from styrene-butadiene copolymers (SBR) and styrene-(meth)acrylic copolymers, for example styrene-(meth)acrylate, having, for example, different glass transition temperatures (Tg) and/or different styrene contents, so as to obtain a compromise between the adhesion and the cohesion of the film adapted to the surface to be treated.

Thus, a first polymer may have a Tg of from −30° C. to −5° C. and a second polymer a Tg of from +5° C. to +50° C.

As examples of blends of polymers in emulsion or in dispersion, it is possible to use a blend of two or more than two latices preferably chosen from styrene-butadiene and styrene-(meth)acrylic latices, for example styrene-(meth)acrylate latices, preferably having different glass transition temperatures and/or different styrene contents.

It is preferable to use a latex free of surfactants that may leave residues on the surface. A styrene-butadiene blend with a higher degree of carboxylation may be used, for example (commercially available under the names Baystal® S42 or S44), which is referred to as a self-dispersing latex, dispersible in emulsions free of surfactants and simply containing an added thickener.

A solution of polyvinyl alcohol (PVA) or of polyvinylpyrrolidone (PVP) (polymers in solution) and/or optionally one or more other polymers in aqueous dispersion chosen, for example, from (meth)acrylic polymers, as defined above, may optionally be added to this blend.

According to the invention, the formulation is free of complexing agents and chelating agents and it is preferably free of fillers when it is desired in particular for the film prepared to be transparent. However, in certain applications, it is possible for the emulsion or formulation known as the “base formulation” to contain one or more fillers chosen, for example, from ZnO, mica or clays known as “nanoclays”. A typical aqueous formulation, preferably free of filler, will contain, for example, from 30% to 60% of water, with SBR added in a proportion of from 20% to 60% by mass and acrylic polymer added in a proportion of from 1% to 20% by mass. The latter polymer may be advantageously replaced with polyvinyl alcohol in the same proportions.

Thus, 2 SBR having different styrene contents, namely Baystal® S42 and S44 may be mixed together, for example, as an aqueous emulsion (of from 30% to 70% water), in a 50/50 proportion, optionally followed by addition thereto of between 1% and 10% of a blend of acrylic polymers based on ethyl acrylate and methacrylic acid (aqueous dispersion containing from 20% to 70% by weight of polymer) and then also optionally addition of a polymer in solution such as PVA.

One particularly preferred composition will comprise, by mass: from 0 to 20% of PVA, for example 15%; from 0 to 50% of Baystal® S42, for example 17.5%; from 0 to 50% of Baystal® S44, for example 17.5%; and from 30% to 70% of water, for example 50%.

When several latices are used, the emulsion is generally prepared by simple mixing of the various latices, preferably with stirring.

This aqueous base formulation emulsion gives the films according to the invention all the advantages stated hereinabove, whereas the components taken separately have drawbacks associated with their poor mechanical strength and their solubility, which do not allow them to be used [5; 7].

The aqueous emulsion of the polymer(s) is then applied to the surface to be cleaned, decontaminated or protected.

There is no limitation as regards the nature and form of the surface to be treated. This surface may be a surface made of metal, organic polymer, glass, stone, plaster, cement, roughcast or the like or a surface comprising several of these materials, or alternatively a painted or enamelled surface; the surface may be non-porous, non-absorbent, or porous, and may be smooth or rough.

Advantageously, the emulsion is formulated so as to allow the formation of a non-porous film on a non-porous support, and the application of the emulsion should be possible on non-absorbent supports such as metals, glass and other plastic supports.

It may also be the surface of the top layer of a one-layer or multilayer protective or decorative coating on a substrate such as a wall, an advertising hoarding, a road sign or the like.

Such a top layer is, for example, a layer of paint, varnish or the like.

The surface may be opaque or transparent; this is one of the advantages of the invention, which is that of allowing the treatment or protection of transparent surfaces, such as inspection ports or glazing, since the film formed according to the invention is generally transparent and colourless due especially to the absence of fillers, and therefore does not mask the surface. This is particularly advantageous on transparent surfaces.

According to the invention, the surface may have any shape, and surfaces of either simple or complex shape may be treated with equal efficiency.

The surface may be of any size, but the invention allows large, or even very large, surfaces to be treated quickly, without modifying them or degrading them.

Since the main application of the invention is the protection of surfaces against unwanted graffiti, inscriptions and markings, irrespective of their nature and their mode of application: aerosol, stamp, etc., the surface may thus especially form part of a wall or of any other part of a building or construction, or of an advertising hoarding or road sign.

The emulsion may be applied to the surface by any known means, for example by spreading with a brush or a roller, or alternatively by projection/spraying.

The film forms (for example over a period of from 1 to 30 minutes) by “in situ” coalescence of the polymer(s) on the surface.

The formation of the film is rapid at the service temperature of the equipment whose surface forms part thereof. By way of example, this temperature may be from 10 to 70° C. and preferably from 5 to 50° C.

The film may generally then be dried, for example by evaporation, at a temperature of from 5 to 50° C.

The film generally becomes transparent on drying (when it contains no fillers). As a result, the surface maintains the visual appearance of an untreated surface. The said film, once formed, acts as a protective agent with respect to external contamination and as an agent for decontaminating and cleaning the said surface due to the removal of the surface layer by rinsing after this layer has been polluted, contaminated or soiled.

The film according to the invention is applied preventively to a clean surface, as an agent for protecting against contamination, or alternatively it may even be applied curatively to decontaminate or clean the surface.

The external contaminants and/or pollutants that may be removed from the surface in the top layer of the film in which they are present, and against which the surface may be protected, are of diverse nature. They may especially be chemical contaminants or pollutants, such as Pb, Cd and/or radioactive contaminants such as caesium, or alternatively biological contaminants (for example bacteriological contaminants).

In particular, the contaminants repelled by the film according to the invention, and which are removed from the surface layer of the said film, are the contaminants and pollutants present in the paints, inks and other marking products that are used to form the unwanted graffiti, markings and other inscriptions. The pollutants will thus be, for example, pigments, binders, resins, polymers, plasticizers or solvents present in such inks and paints.

In a first embodiment, the emulsion or base formulation may be applied directly to the surface, like a paint, where it will form a film on drying.

The surface of the film is treated after drying using a specific surfactant or other product that facilitates its removal, for example its dissolution. In this case, the thickness of the film, for example from 5 to 500 μm, in which the surfactant or other agent has penetrated becomes, for example, soluble in aqueous media under specific conditions, for example in terms of temperature and pH, and the removal of the graffiti takes place by washing or rinsing with a washing fluid such as an aqueous medium, for example an aqueous solution. The washing may be performed under pressure and the fluid may simply be water that has optionally been heated, for example at from 0 to 145° C., and optionally under pressure.

The washing or rinsing entails the redissolution or reemulsification of the treated fraction of the film. The graffiti is then removed at the same time as the said dissolved fraction of the film. The untreated part of the film remains intact. It is thus possible to retreat the surface of the remaining film, for example with the same surfactant or another component, and to repeat the operation until the film has been totally consumed.

If the surface of the film is not treated with an additive that facilitates its dissolution, then the whole film is removed by peeling like a skin and the graffiti that leaves with the said skin is thus removed.

In the case where dissolution of the surface layer of film is performed in aqueous medium, for example in an aqueous solution, the organic material is separated out by flocculation by introducing a specific Bayer® flocculant, followed by filtration of the flocs thus formed. The organic material thus recovered may be destroyed by incineration.

The contaminants or pollutants are themselves separated out by filtration, generally in the form of insoluble granules.

In another embodiment, the base formulation may be separated into two (or more) batches, to which will be added two (or more) different types of surfactants or other additives. For example, two types of surfactant A and B may be used such that the respective polymer films containing them are soluble under different conditions for washing A and B, for example different pH, and/or different temperature, and/or different overall chemical composition of the washing solution.

In this case, a multilayer film is developed with alternating application of the formulations A and B.

When the surface is soiled with graffiti, it suffices to wash the surface with a washing solution of type A if a layer containing formulation A is present at the surface. The graffiti is removed at the same time as the said layer, while the underlying layer of formulation B remains intact. When the layer of formulation B is polluted, it suffices to remove it using a washing solution of type B, and so on, until the multilayer film has been completely consumed. The processing of the removal or dissolution effluents is analogous to that described in the context of the first embodiment.

The film and the processes according to the invention find their application in any preventive treatment against contamination or pollution—irrespective of the nature and form thereof—of any surface.

The process and the film according to the invention are essentially preventive, which means that the film is applied to non-degraded surfaces to protect them against subsequent inscriptions applied thereon.

The invention will now be described with reference to the example that follows, which is given as a non-limiting illustration.

### EXAMPLE

An aqueous emulsion (45% to 55% by mass of water) free of fillers, comprising a blend in equal parts (50/50) of two types of SBR with different styrene contents (Baystal® S42 and S44) is prepared. A blend of acrylic polymers based on ethyl acrylate and methacrylic acid is added to this emulsion, with stirring, in the form of a suspension containing from 28% to 32% by mass of water.

Once the coating has been spread onto a wall such as a building wall or a road sign by means of a simple application mode such as a brush, a roller or by spraying, the coating is dried in ambient air at a temperature of between 5° C. and 50° C. and at a relative humidity of between 10% and 80%. The drying time varies depending on the thickness: for 200 μm, it takes between 1 hour and 3 hours. The drying is readily detected, since the coating gradually becomes transparent. A mixture of nonionic surfactants comprising 50% by weight of fatty acid ester and 50% by weight of ethoxylated alkylphenol is applied with a brush to the dry coating. On drying in ambient air, it penetrates the outer surface of the film.

Next, graffiti or black paint in aerosol form is sprayed onto the dry coating and left to dry in ambient air.

The sample is treated with hot water and a thin layer of polymer is removed naturally, entraining with it the graffiti. The surface of the coating is then milky (since it is wet), but is cleaned of all trace of graffiti. On drying, the coating regains its transparent appearance and is then ready for another graffiti-cleaning operation.

### REFERENCES

[1] Saidi S., Guittard F., Géribaldi S., Polymères contre graffiti. Actualité chimique March 2001; 3-13.
[2] Pomero V. FR-A-2 686 615 of 27 Jan. 1992.
[3] Salvoldelli C., WO-A-80 01072 of 16 Nov. 1979.
[4] Turzan G., FR-A-2 630 353 of 25 Apr. 1988.
[5] Hansen R. P., U.S. Pat. No. 4,169,088 of 30 May 1978.
[6] Swensson S., U.S. Pat. No. 5,750,189 of 10 Sep. 1996.
[7] Rawlins P. R., U.S. Pat. No. 4,428,994 of 15 Jul. 1981.

1. Multilayer film comprising a surface layer and at least one other layer under the said surface layer, each of the said surface layers and of the other layers comprising at least one organic polymer and being free of complexing agents, chelating agents and optionally of mineral fillers, and the said surface layer also comprising at least one agent capable of promoting the removal of the said surface layer by a rinsing liquid.

2. Multilayer film according to claim 1, in which at least one of the said other layers under the said surface layer also comprises at least one agent capable of promoting the removal of the said layer by a rinsing liquid.

3. Multilayer film according to claim 2, which comprises, alternately, a first layer comprising at least one agent capable of promoting the removal of the said layer by a rinsing liquid, and a second layer not comprising any agent capable of promoting the removal of the said second layer by a rinsing liquid.

4. Multilayer film according to any of claims 1 and 2, in which all the layers of the film comprise at least one agent capable of promoting their removal by a rinsing liquid.

5. Multilayer film according to claim 4, in which two successive layers each contain a different agent capable of promoting the removal of the said layers by a rinsing liquid.

6. Multilayer film according to claim 5, comprising, alternately, a first layer comprising a first agent capable of promoting the removal of the said first layer by a rinsing liquid, and a second layer comprising a second agent that is different from the first agent and is capable of promoting the removal of the said second layer by a rinsing liquid.

7. Multilayer film according to claim 5 or 6, in which the said different agents differ in at least one of the conditions under which they promote the removal of the layer in which they are present, by the rinsing liquid.

8. Film according to claim 7, in which the said conditions are chosen from the temperature, the pH, the composition of the rinsing liquid, and the pressure of the rinsing liquid, such as water.

9. Film according to any one of claims 1 to 8, in which the agent(s) capable of promoting the removal of a layer by a rinsing liquid is (are) chosen from agents capable of promoting the dissolution of the said layer in a rinsing liquid, and agents capable of promoting the emulsification of the layer in a rinsing liquid.

10. Film according to claim 9, in which the agents capable of promoting the dissolution of a layer are chosen from surfactants, preferably from nonionic, anionic and cationic surfactants; and other additives, such as acids and bases.

11. Film according to claim 10, in which the said surfactants are chosen from surfactants allowing the dissolution of the layer in which they are present under the effect of an acidic washing liquid, and surfactants allowing the dissolution of the layer in which they are present under the effect of a basic washing liquid.

12. Multilayer film according to any one of claims 5 to 11, which comprises, alternately, a layer comprising a first surfactant A and a layer containing a second surfactant B that can be dissolved under different washing conditions.

13. Multilayer film according to claim 12, in which the first surfactant A is a surfactant that promotes the dissolution of the layer in which it is present by an acidic washing liquid, and the second surfactant B is a surfactant that promotes the dissolution of the layer in which it is present by a basic washing liquid, or vice versa.

14. Film according to any one of the preceding claims, in which the surface layer is from 5 to 500 μm and preferably from 5 to 100 μm thick.

15. Film according to any one of the preceding claims, in which the total thickness of the film is from 5 μm to 2 mm and preferably from 50 to 500 μm.

16. Film according to any one of the preceding claims, in which there are from 1 to 50 and preferably from 1 to 20 layers other than the surface layer.

17. Film according to any one of the preceding claims, characterized in that it is non-porous.

18. Film according to any one of the preceding claims, in which the polymer is chosen from polymers that may be in the form of aqueous emulsions of latex type.

19. Film according to any one of claims 17 and 18, in which the polymer is a self-dispersing polymer.

20. Film according to any one of claims 18 and 19, in which the polymer is chosen from styrene-butadiene copolymers, styrene-(meth)acrylic copolymers, for example styrene-(meth)acrylate copolymers and (meth)acrylic polymers.

21. Film according to any one of claims 18 to 20, in which each layer comprises several polymers that may be in the form of aqueous emulsions, the said polymers also preferably having different glass transition temperatures (Tg).

22. Film according to any one of claims 18 to 21, in which each layer also comprises one or more other polymers that may be in aqueous solution, preferably chosen from polyvinyl alcohol (PVA) and polyvinylpyrrolidone (PVP).

23. Film according to any one of the preceding claims, in which all the layers comprise the same polymer(s).

24. Process for forming a multilayer film according to claim 1, comprising a surface layer and one other layer underneath the said surface layer, the said surface layer and the said other layer comprising the same organic polymer and being free of complexing agents, chelating agents and optionally mineral fillers, in which the following successive steps are performed:
a)—an aqueous emulsion of the said organic polymer is formed;
b)—the said emulsion comprising the organic polymer is applied to the surface, by means of which the film forms by coalescence;
c)—the surface of the said film is impregnated with at least one agent capable of promoting the removal of a surface layer of the film by a rinsing liquid, so as to form a surface layer of the film containing at least one agent capable of promoting the removal of the said surface layer from the film by a rinsing liquid.

25. Process according to claim 24, in which the film forms by coalescence at room temperature or at the service temperature of the surface.

26. Process according to claim 24, comprising between steps b) and c), a step of drying the film.

27. Process according to any one of claims 24 to 26, in which the agent capable of promoting the removal of the surface layer of the film is chosen from agents capable of promoting the dissolution of the surface layer, such as surfactants.

28. Process for forming a multilayer film according to claim 1, comprising a surface layer and at least one other layer underneath the said surface layer, the said surface layer and the said other layer comprising the same organic polymer and being free of complexing agents, chelating agents and optionally of mineral fillers, in which the following successive steps are performed:
a) an aqueous emulsion of the said organic polymer is formed;
b) the said emulsion is separated into a first portion and a second portion,
c) a first agent capable of promoting the removal of a layer of the organic polymer under the effect of a rinsing liquid is added to the first portion,
d) optionally, a second agent capable of promoting the removal of a layer of the organic polymer under the effect of a rinsing liquid is added to the second portion,
e) the said second and first portions of the emulsion are successively applied to a surface, by means of which a film is formed, comprising, from its surface, a layer comprising a first agent capable of promoting its removal by a washing liquid and a second layer comprising a second agent capable of promoting its removal by a washing liquid or not comprising the said second agent,
f) step e) is optionally repeated, for example from 1 to 40 times and preferably from 1 to 20 times.

29. Process according to claim 28, in which the said first and second agents differ in at least one of the conditions under which they promote the removal, for example the dissolution, of the layer in which they are present, by the rinsing liquid.

30. Process according to claim 29, in which the said conditions are chosen from the temperature, the pH, the composition of the rinsing liquid, and the pressure of the rinsing liquid.

31. Process according to claim 29, in which the first agent is a surfactant A and the second agent is a surfactant B.

32. Process according to claim 30, in which the surfactant A is a surfactant that promotes the dissolution of the layer in which it is present under the effect of a liquid, for example an acidic aqueous washing solution, and the second surfactant B is a surfactant that promotes the dissolution of the layer in which it is present under the effect of a liquid, for example a basic aqueous washing solution, or vice versa.

33. Process according to claim 28, in which the formation of the film takes by coalescence at room temperature or at the service temperature of the surface.

34. Process according to claim 28, also comprising a final step g) of drying the film.

35. Process for protecting, decontaminating or cleaning a surface, in which the following successive steps are performed:
a film according to any one of claims 1 to 23 is formed on the said surface;
the film is left in contact with the said surface until it has been contaminated or polluted, especially with graffiti or other unwanted inscriptions or markings; and
the polluted or contaminated surface layer of the said film is removed by rinsing with a liquid, preferably an aqueous liquid, such as an aqueous solution.

36. Process for protecting, decontaminating or cleaning a surface, in which the following successive steps are performed:
a) a film is formed on the said surface via the process according to any one of claims 24 to 27,
b) the film is left in contact with the said surface until it has been contaminated or polluted, especially with graffiti or other unwanted inscriptions or markings,
c) the polluted or contaminated surface layer of the said film is removed by rinsing with a liquid, preferably an aqueous liquid such as an aqueous solution, and
d) the surface of the film is optionally impregnated with at least one agent capable of promoting the removal of a surface layer from the film, so as to form a surface layer containing at least the said agent,
e) steps c) and d) are optionally repeated until the film has been consumed.

37. Process for protecting, decontaminating or cleaning a surface, in which the following successive steps are performed:
a) a film is formed on the said surface via the process according to any one of claims 28 to 34,
b) the film is left in contact with the said surface until it has been contaminated or polluted, especially with graffiti or other unwanted inscriptions or markings,
c) the first polluted or contaminated layer of the said film is removed by rinsing with a liquid,
d) the film is left in contact with the said surface until it has been contaminated or polluted,
e) the polluted or contaminated second layer of the said film is removed by rinsing with a liquid, preferably an aqueous liquid, such as an aqueous solution,
f) steps b) to e) are optionally repeated until the film has been consumed.

38. Process according to claim 37, in which the first and second layers are removed under different rinsing conditions such as different temperatures, different pH, different compositions of the rinsing liquid or different pressures of the rinsing liquid.

39. Process according to claim 38, in which the first layer, which contains a surfactant A, is removed by washing with an aqueous liquid, for example an acidic aqueous washing solution, and the second layer, which contains a surfactant B, is removed by washing with an aqueous liquid, for example a basic aqueous washing solution.

40. Surface layered with the film according to any one of claims 1 to 23.

41. Surface according to claim 40, chosen from surfaces made of glass, organic polymer, stone, plaster, cement, roughcast or metal; surfaces comprising several of these materials, or alternatively painted and/or enamelled surfaces.

42. Substrate comprising a surface according to either of claims 40 and 41.
